(19) United States
(12) Patent Application Publication
(10) Pub. No.: US 2009/0243389 A1
(43) Pub. Date: Oct. 1, 2009

(54) Multiple output magnetic induction unit and a multiple output micro power converter having the same

(75) Inventors: Masaharu Edo, Tokorozawa-shi (JP); Takayuki Hirose, Sagamihara-shi (JP)

Correspondence Address: KANESAKA BERNER AND PARTNERS LLP, 1700 DIAGONAL RD, SUITE 310, ALEXANDRIA, VA, 22314-2848, US

(73) Assignee: FUJI ELECTRIC DEVICE TECHNOLOGY CO., LTD., Tokyo (JP)

(21) Appl. No.: 12/379,949

(22) Filed: Mar. 5, 2009

(30) Foreign Application Priority Data
Mar. 31, 2008 (JP) 2008-091391

(51) Int. Cl. H02M 3/335; H01F 27/28; H01F 5/00

(52) U.S. Cl. 307/31; 336/171; 336/200; 336/229

(57) ABSTRACT

A multiple output magnetic induction unit includes a magnetic substrate, and a plurality of toroidal coils mounted on the magnetic substrate side by side. No insulating layer is required between the toroidal coils.

### BACKGROUND OF THE INVENTION AND RELATED ART STATEMENT

The present invention relates to a multiple output magnetic induction unit having a plurality of coils formed on a single magnetic substrate and a multiple output power converter such as DC-DC converter including such a unit.

Recently, electronic information apparatuses, in particular a variety of portable electronic information apparatuses, have been widely used. Many of the electronic information apparatuses have a battery as a power source and are equipped with a power converter such as a DC-DC converter. A power converter generally has a hybrid type module structure comprising active and passive discrete components arranged on a printed circuit board made of ceramic or plastic. The active components include switching devices, rectifying devices and controller ICs. The passive components include inductors, transformers, capacitors and resistors.

A DC-DC converter comprises an input capacitor, an output capacitor, a regulator resistor, a capacitor, an inductor, and a power supply IC. A DC voltage Vin is input so that a MOSFET of the power supply IC is switched on and off to output a specified DC output voltage Vout. The inductor and the output capacitor compose a filter circuit for outputting the DC voltage.

When a DC resistance of the inductor in the circuit increases, a voltage drop at the component increases, resulting in a decrease of the output voltage, i.e., a decrease of conversion efficiency of the DC-DC converter.

With a demand for reducing a size of a variety of electronic information apparatuses including the portable device described above, it has been urgently required to reduce a size of a power converter installed in the apparatus. A size of the hybrid type power supply module has been reduced through advances in MCM (multiple-chip module) technique and a laminated ceramic component.

However, since it is necessary to arrange discrete components on a single substrate, reduction of a mounting area of the power supply module has been limited. In particular, magnetic induction components such as inductors and transformers are much larger than ICs, thereby creating the biggest limitation on the reduction of a size of the electronic apparatus.

There have been two approaches for reducing a size of the magnetic induction component. The first approach is that a size of the magnetic induction component is reduced to a limit as a chip part, and a total size of a power supply is reduced by planar mounting of the chip part. The second approach is that the magnetic induction component is formed on a silicon substrate as a thin film. Recently, to meet the demand for minimizing the magnetic induction component, an example has been disclosed in which a thin micro magnetic component (a coil or a transformer) is mounted on a semiconductor substrate by applying the semiconductor technology.

Patent Document 1 (Japanese Unexamined Patent Application Publication No. 2001-196542) discloses a planar type thin film magnetic induction component in which semiconductor components such as switching elements and controller circuits are incorporated into a semiconductor substrate, and a planar magnetic induction component (thin film inductor) formed of a thin film coil sandwiched by a magnetic thin film and a ferrite substrate is formed on a surface of the semiconductor substrate by thin film technology. With this approach, it is possible to reduce a thickness of the magnetic induction component and a mounting area thereof. However, it is still necessary to mount a large number of discrete chip parts. Therefore, a mounting area is still large.

To solve the problem, a micro power converter with a different construction has been disclosed in Patent Document 2 (Japanese Unexamined Patent Application Publication No. 2002-233140). In Patent Document 2, a planar magnetic induction component in the micro power converter has a spiral-shaped coil conductor with a gap filled with a resin containing magnetic fine particles and sandwiched by ferrite substrates on upper and lower surfaces thereof.

Another micro power converter exhibiting high efficiency has been disclosed in Patent Document 3 (Japanese Unexamined Patent Application Publication No. 2004-072815). In Patent Document 3, the micro power converter is a combination of an inductor and a power supply IC, and the inductor comprises a solenoid coil.

The micro power converters described above, while having a small size and thickness, has only a single magnetic inductor component and a single IC for a single output system having one input and one output. When multiple outputs are necessary, it is necessary to provide a plurality of micro power converters.

Many of portable devices and electronic apparatuses that need a micro power converter require a plurality of output systems or voltages. Therefore, it is necessary to mount such a number of micro power converters as the number of the output systems, resulting in increase of a mounting area of the micro power converters and mounting cost.

To solve the problem, a construction for a plurality of output voltages has been disclosed (Japanese Unexamined Patent Application Publication No. 2004-343976 and corresponding United States Patent Application Publication No. 2004-0179383A1: Patent Document 4), in which a plurality of magnetic induction components is arranged and magnetically isolated from each other.

In the micro power converter disclosed in Patent Document 4, due to the coil conductors constructed in a solenoid configuration, the magnetic flux leaks through the coil conductors of the adjacent solenoid. In order to inhibit a magnetic coupling between the adjacent coils, a slit is formed in the magnetic substrate for magnetic isolation.

This structure needs steps of forming a magnetic isolation layer including a step of cutting the slit in the magnetic substrate and a step of filling the slit with an insulator. Thus, it causes problems of an enlarged inductor substrate, increase in cost, and degradation of efficiency percentage due to cracks in the substrate.

Although Patent Document 4 mentions that the magnetically isolated solenoid coil can be a toroidal coil, it does not mention about elimination of a magnetic isolation layer.

Therefore, it is an object of the present invention to solve the above problems and provide a small and thin multiple output magnetic induction unit and a small, thin and inexpensive multiple output micro power converter having the same for performing output of plural voltages.

Further objects and advantages of the invention will be apparent from the following description of the invention.

### SUMMARY OF THE INVENTION

To achieve the above object, a multiple output magnetic induction unit of the invention has a plurality of toroidal coils on a single magnetic substrate.

Preferably, the multiple output magnetic induction unit does not have any magnetic isolation layer on the magnetic substrate for inhibiting magnetic interaction between the adjacent toroidal coils. This structure achieves minimization of a magnetic substrate and reduction in manufacturing steps.

Advantageously, the magnetic substrate is an insulative substrate.

It is advantageous that electrodes are provided on the first principal surface and a second principal surface of the magnetic substrate, the electrode on the first principal surface being electrically connected to the electrode on the second principal surface through a through hole.

A multiple output micro power converter of the invention comprises at least the multiple output magnetic induction unit as defined above, a power supply IC, and a capacitor.

By making the coil conductors in a toroidal configuration, a plurality of inductors can be integrated at a low cost without forming a magnetic isolation layer in the magnetic substrate to form a multiple output magnetic induction unit and a multiple output micro power converter having the magnetic induction unit. Thus, a plurality of power converters, which is conventionally needed according to a plurality of output voltages, can be integrated to one converter, thereby decreasing the packaging area and costs.

### BRIEF DESCRIPTION OF THE DRAWINGS

FIG. 1 is a top plan view of an essential part of a multiple output magnetic induction unit according to the first embodiment of the present invention.

FIG. 2 is a sectional view of an essential part taken along line 2-2 in FIG. 1.

FIG. 3 is a sectional view of an essential part taken along line 3-3 in FIG. 1.

FIGS. 4(a) and 4(b) show schematically a flow of magnetic flux in a unit having two inductors when electric current is supplied to one inductor, wherein FIG. 4(a) is in the case of a toroidal coil, and FIG. 4(b) is in the case of a solenoid coil.

FIG. 5 is a sectional view showing an essential step of fabricating the multiple output magnetic induction unit as shown in FIGS. 1 through 3.

FIG. 6 is a sectional view showing an essential step of fabricating the multiple output magnetic induction unit as shown in FIGS. 1 through 3 continued from FIG. 5.

FIG. 7 is a sectional view showing an essential step of fabricating the multiple output magnetic induction unit as shown in FIGS. 1 through 3 continued from FIG. 6.

FIG. 8 is a sectional view showing an essential step of fabricating the multiple output magnetic induction unit as shown in FIGS. 1 through 3 continued from FIG. 7.

FIG. 9 is a sectional view showing an essential step of fabricating the multiple output magnetic induction unit as shown in FIGS. 1 through 3 continued from FIG. 8.

FIG. 10 is a sectional view showing an essential step of fabricating the multiple output magnetic induction unit as shown in FIGS. 1 through 3 continued from FIG. 9.

FIG. 11 is a sectional view showing an essential step of fabricating the multiple output magnetic induction unit as shown in FIGS. 1 through 3 continued from FIG. 10.

FIG. 12 is a sectional view showing an essential part of a multiple output micro power converter according to the second embodiment of the invention.

FIG. 13 is a sectional view showing an essential part of a multiple output micro power converter according to the third embodiment of the invention.

### DETAILED DESCRIPTION OF PREFERRED EMBODIMENTS

Some preferred embodiments of the invention will be described in the following with reference to accompanying drawings.

### First Embodiment

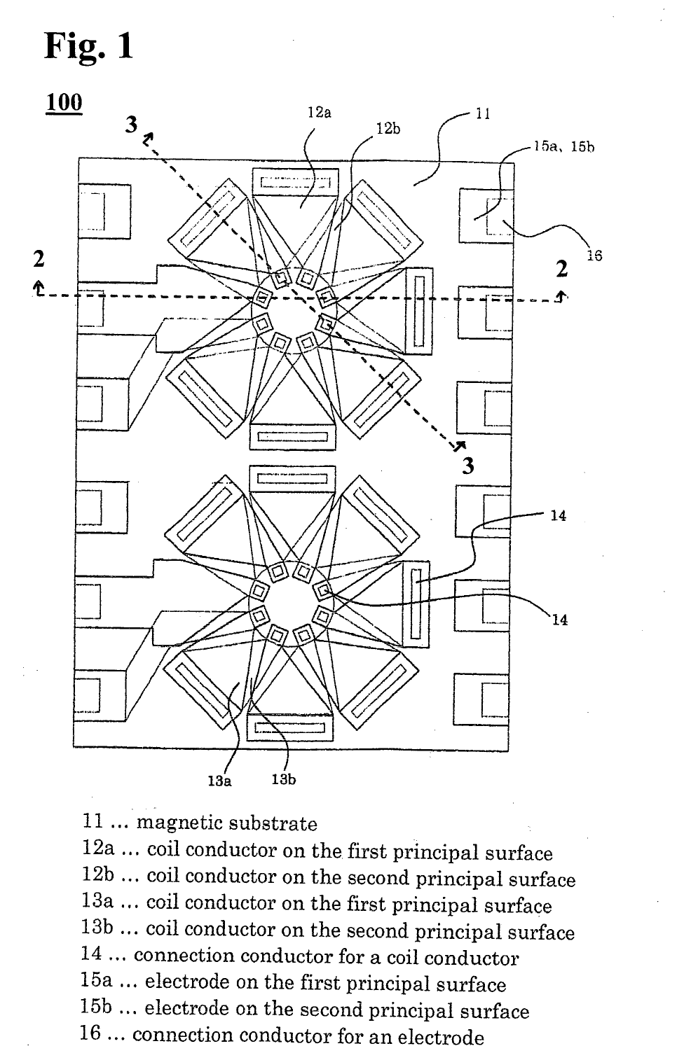

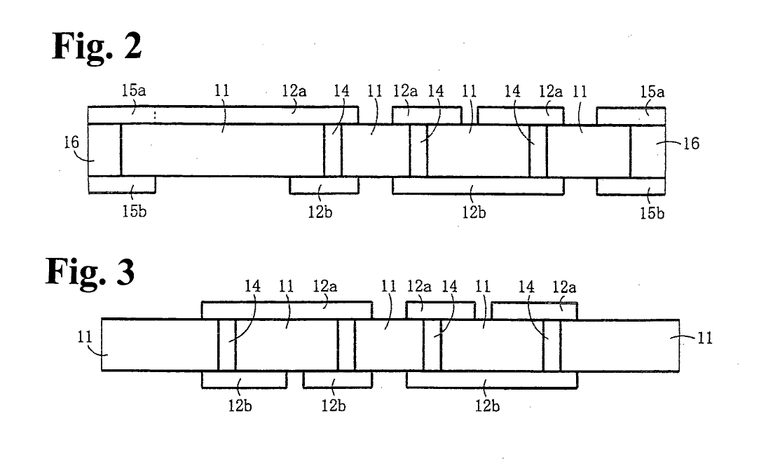

FIGS. 1 through 3 shows a structure of a multiple output magnetic induction unit according to the first embodiment of the invention, in which FIG. 1 is a top plan view of an essential part, FIG. 2 is a sectional view of the essential part taken along line 2-2 in FIG. 1, and FIG. 3 is sectional view of the essential part taken along line 3-3 in FIG. 1. The multiple output magnetic induction unit 100 depicted in FIGS. 1 through 3 has two inductors of toroidal coils formed on a magnetic substrate 11. FIGS. 1 through 3 illustrate coil configurations of the inductor (coil conductors 12a, 12b, 13a, 13b in a configuration of a toroidal coil) and further, electrodes 15a, 15b for electrical connection.

The coil conductors 12a, 12b, 13a, 13b are formed using a magnetic substrate 11 for example, a ferrite substrate. The coil conductors 12a, 13a on the first principal surface are electrically connected to the coil conductors 12b, 13b on the second principal surface through connection conductors 14 in through holes. The coil conductors 12b, 13b on the second principal surface are formed with a relatively oblique angle with respect to the coil conductors 12a, 13a on the first principal surface to connect to the adjacent two coil conductors on the first principal surface. Overall coil configuration is toroidal.

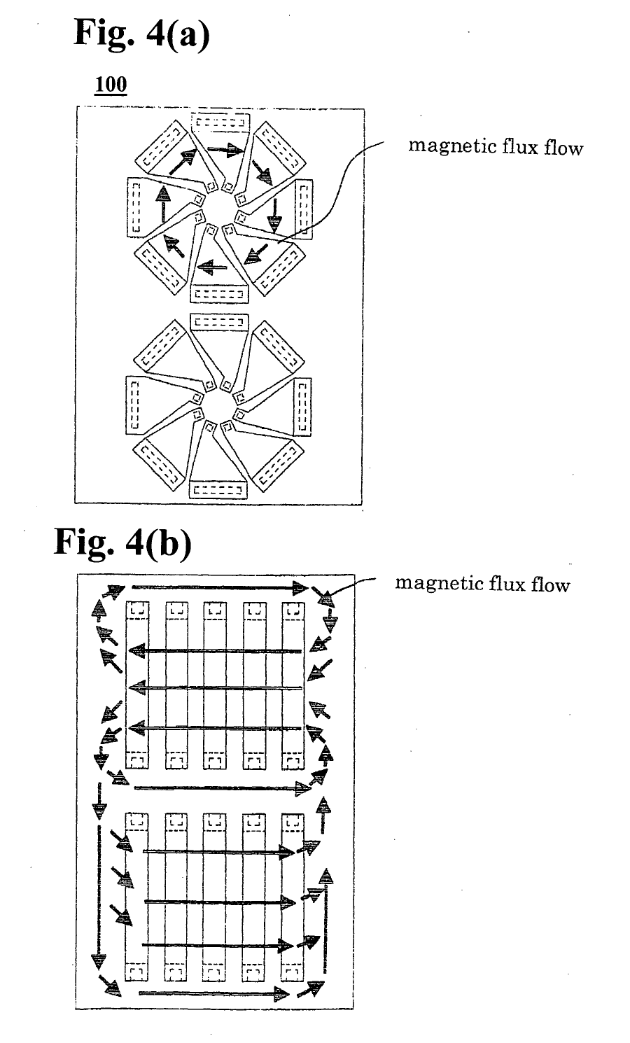

FIGS. 4(a) and 4(b) show schematically the magnetic flux flow when an electric current is supplied to one of the two inductors that are formed on a single magnetic substrate. FIG. 4(a) shows the case of the coil conductors in a toroidal configuration and FIG. 4(b) shows the case of the coil conductors in a solenoid configuration. Here, an inductor means a magnetic substrate and coil conductors formed on the magnetic substrate. FIG. 4(b) shows, as a comparative example, the magnetic flux flow in the case of a coil with a solenoid configuration disclosed in Patent Document 4 and without any magnetic isolation layer. FIGS. 4(a) and 4(b) indicate solely coil conductors on the first principal surface.

In the case of a coil with a solenoid configuration as shown in FIG. 4(b), the magnetic flux flows outside a coil and affects flux flow in an adjacent coil. Accordingly, it is necessary to magnetically isolate the adjacent coils from each other with a non-magnetic material.

On the other hand, in the case of a coil with a toroidal configuration according to the present invention as shown in FIG. 4(a), the magnetic flux flows in a region within a coil and scarcely affects flux flow in an adjacent coil, requiring no magnetic isolation.

Thus, a multiple output magnetic induction unit 100 of the invention does not need a magnetic isolation layer as described in Patent Document 4 and can be fabricated in a small number of steps at a reduced cost. Moreover, since the unit can be fabricated without a step that may degrade strength of the substrate such as a step of cutting a slit, the magnetic substrate 11 does not suffer from any break, thereby enhancing efficiency percentage. In addition, an area of the substrate 11 is reduced.

While the multiple output magnetic induction unit 100 of the first embodiment is not a transformer but a coil or an inductor, the unit can be applied to a case of a transformer. In that case, a multiple output magnetic induction unit mounting a transformer can be constructed by forming two sets of windings in a toroidal configuration in the region of one toroidal coil in the first embodiment, although any drawing of a transformer is not given.

FIGS. 5 through 11 are sectional views showing essential steps of manufacturing the multiple output magnetic induction unit of FIGS. 1 through 3, illustrating in the order of manufacturing steps. These sectional views of essential manufacturing steps are similar to the sectional view taken along the line 3-3 in FIG. 1.

A ferrite substrate formed of Ni—Zn and having a thickness of 525 μm is used for the magnetic substrate 11. A thickness of the magnetic substrate is determined according to required inductance, a magnitude of coil current, and properties of the magnetic substrate 11, and is not limited to the magnitude of the embodiment. If the magnetic substrate has an extremely small thickness, magnetic saturation is prone to occur, and if the substrate has a large thickness, the power converter itself has a large thickness. Consequently, it is necessary to select a thickness according to a purpose of the power converter. While the ferrite is used for the magnetic substrate 11 in this embodiment, any other insulative magnetic material can be alternatively used for the magnetic substrate 11. The ferrite substrate is selected in this embodiment since it is easy to form in a substrate shape. Specific manufacturing steps are described in the following.

First, as shown in FIG. 5, through holes are formed in the magnetic substrate 11 for connecting coil conductors and electrodes to be formed on the first principal surface and those on the second principal surface. The coil conductors 12a, 12b are connected through the through-hole 42, and the electrodes 15a, 15b are connected through the through-hole 43. A method for forming the through-holes can be selected from laser beam machining, sand blasting, electric discharge machining, ultrasonic machining, and drilling according to machining cost and machining dimension. In this embodiment, the sand blasting method is employed because a minimum width of machining dimension is a minute value of 130 μm and a large number of places need to be machined.

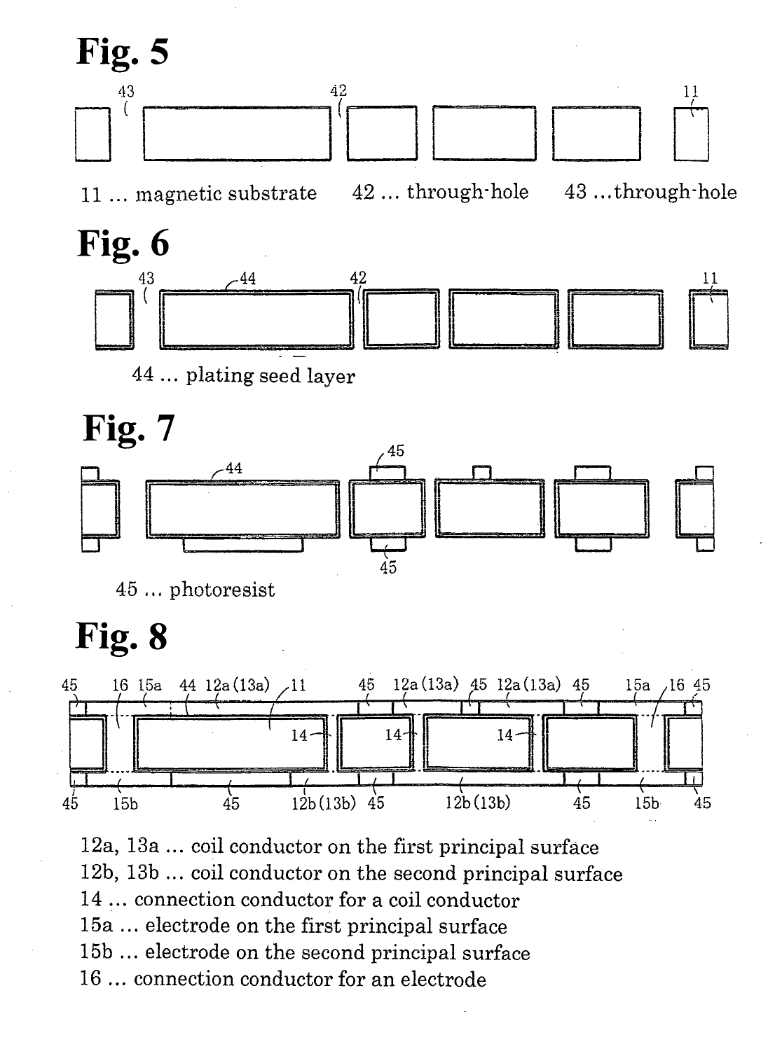

Then, as shown in FIG. 6, Ti/Cu is deposited to give electric conductivity to the whole surface of the substrate by a sputtering method, to form a plating seed layer 44. The through-holes are also given conductivity in this step. Electroless plating can be employed in this step if necessary. Instead of the sputtering method, a vacuum deposition method or a CVD (chemical vapor deposition) method may be employed as well. The plating seed layer 44 can be formed only by electroless plating method.

It is desired that the deposited layer has a sufficient adhesiveness to the substrate. The conductive material can be any material exhibiting appropriate electrical conductivity. While titanium is used for an adhesive layer to obtain good adhesiveness in this embodiment, other materials such as Cr, W, Nb, and Ta can be used, too. The copper layer is a seed layer for a layer to be plated in a later step of electroplating. The seed layer can be formed of nickel or gold as well. A film construction of Ti/Cu is used in this embodiment for ease of machining in the later steps.

Then, as shown in FIG. 7, a pattern 45 of photo-resist is formed for the coil conductors and electrodes to be formed on the first principal surface and the second principal surface. A negative film type photo-resist is used to form the pattern in the embodiment.

Then, as shown in FIG. 8, copper is plated by electroplating at the places of openings in the resist pattern. The through-holes are plated with copper to form the connecting conductors. The coil conductors 12a, 13a on the first principal surface and the coil conductors 12b, 13b on the second principal surface are connected with the connecting conductors, to form a pattern of a coil with a toroidal configuration. A pattern of the electrodes 15a and 15b is simultaneously formed in this step. The connecting conductors 14 and 16 are formed in the through-holes.

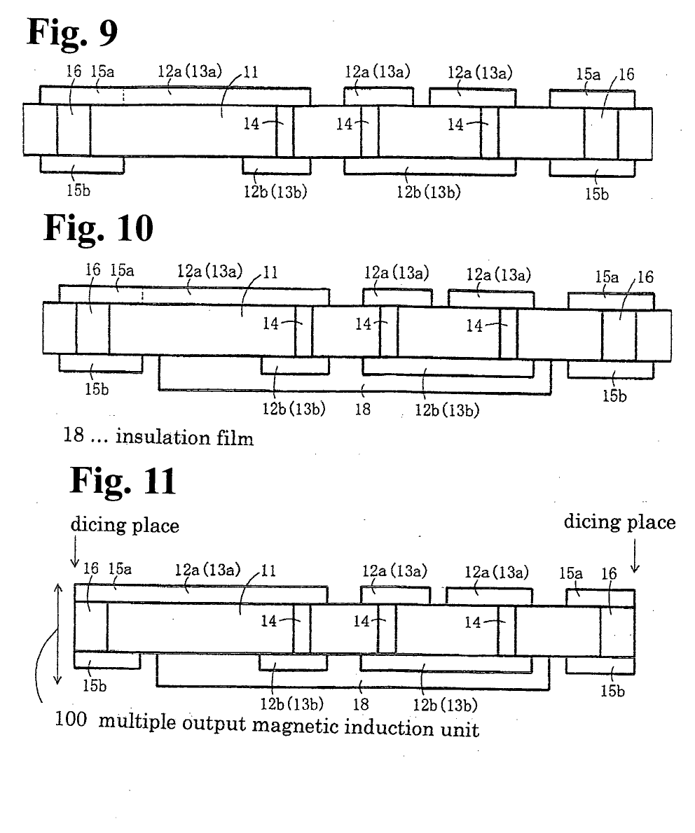

After the electroplating, as shown in FIG. 9, unnecessary photo-resist and conductive layer are removed to obtain intended coil conductors and electrodes. Since the coil conductors and the electrodes include the plating seed layer, the plating seed layer is not depicted in FIG. 8 and the drawings for the following steps.

Then, as shown in FIG. 10, an insulation film 18 is formed on the coil conductors, as necessary. A film type insulation material is used in this embodiment. The insulation film serves a function of a protective film, and can be omitted if unnecessary. However, it is preferable that the insulation film is formed for long-term reliability. The insulation film material is not limited to the film type material, but a liquid insulation material can be applied by screen printing in a pattern and thermally cured.

Finally, as shown in FIG. 11, the ferrite substrate is cut by dicing into a predetermined size for obtaining intended multiple output magnetic induction units having a plurality of inductors arranged thereon.

If necessary, nickel or gold may be plated on the surfaces of the coil conductors and the electrodes to form a surface treatment layer. In the step shown in FIG. 8 in this embodiment, nickel and gold are sequentially plated by electroless plating immediately after copper is electro-plated. The surface treatment layer may be formed by electroplating after the step in FIG. 10 or the step in FIG. 11. The protective metallic conductive layer is provided for obtaining stable connection when the IC is connected in a later step.

Through the manufacturing method described above, a multiple output magnetic induction unit 100 having a plurality of inductors arranged thereon is obtained without the complicated steps of forming the magnetic isolation layer and the slit as disclosed in Patent Document 4.

### Second Embodiment

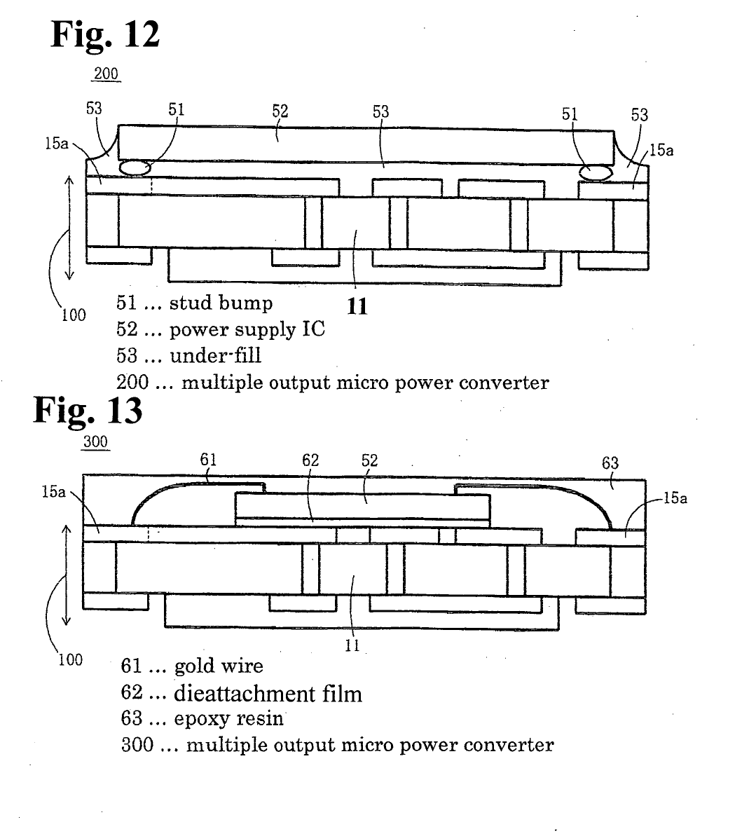

FIG. 12 is a sectional view of an essential part of a multiple output micro power converter according to the second embodiment of the invention. The multiple output micro power converter 200 includes the multiple output magnetic induction unit 100 shown in FIGS. 1 through 3. A planar packaging technique is used for connection between the multiple output magnetic induction unit 100 and the power supply IC 52.

The power supply IC 52 is connected to the electrodes 15a formed on the magnetic substrate 11 as shown in FIG. 12. In this embodiment, stud bumps 51 are formed on electrodes (not shown) of the power supply IC, and the power supply IC 52 is fixed on the electrodes 15a by ultrasonic bonding. Then, the power supply IC 52 is fixed to the multiple output magnetic induction unit 100 with the under-filling 53.

In this embodiment, the power supply IC is fixed to the magnetic induction unit using the stud bumps 51 and ultrasonic bonding. A method of fixing is not limited thereto, and soldering or a conductive adhesive can be used without any problem. It is preferred that a connection part has a resistance as small as possible.

The under-filling is used for fixing the power supply IC 52 to the multiple output magnetic induction unit 100. An appropriate material can be a sealant of epoxy resin, for example. The fastening material is used to fasten the components and eliminate an adverse effect of moisture to attain long-term stability. It has no effect on initial performance of the multiple output micro power converter, but it is preferable to provide a fastening material for the long-term stability.

Through the process described above, it is possible to reduce a size of the power converter with the parts (the power supply IC 52 and the multiple output magnetic induction unit 100) mounted thereon other than a capacitor. The multiple output micro power converter 200 has two output systems, and can be manufactured by a small number of steps without a step of forming a magnetic isolation layer as in the conventional technology.

### Third Embodiment

FIG. 13 is a sectional view of an essential part of a multiple output micro power converter according to the third embodiment of the invention. The multiple output micro power converter 300 comprises the multiple output magnetic induction unit 100 shown in FIGS. 1 through 3 and utilizes the wire-bonding technique to connect the multiple output magnetic induction unit 100 and the power supply IC.

The power supply IC 52 with a die attachment film 62 pasted on the back surface thereof is mounted on the magnetic substrate 11, and electrodes (not shown) on the power supply IC 52 are connected to the electrodes 15a on the magnetic substrate 11 by wire bonding with gold wires 61. After the wire bonding, a sealing process is carried out with a sealant of epoxy resin 63, for example. While an adhesive of a die attachment film 62 is used for mounting the power supply IC 52 in the embodiment, a liquid adhesive may be used.

While gold wires 61 are used, aluminum wires can alternatively be used. Connection by wire bonding, as compared with the planar packaging technique, has fewer limitations on the size and pad positions of the power supply IC 52 and gives more freedom of layout relative to the ferrite substrate 11. Therefore, a small-sized power supply IC 52 causes no problem, thereby reducing a cost.

In the second and third embodiments, a capacitor such as a laminated ceramic capacitor can be disposed on the back surface of the magnetic substrate 11.

The disclosure of Japanese Patent Application No. 2008-091391 filed on Mar. 31, 2008 is incorporated as a reference.

While the invention has been explained with reference to the specific embodiments of the invention, the explanation is illustrative and the invention is limited only by the appended claims.

What is claimed is:

1. A multiple output magnetic induction unit, comprising:
a magnetic substrate, and
a plurality of toroidal coils mounted on the magnetic substrate side by side.

2. The multiple output magnetic induction unit according to claim 1, wherein each of the toroidal coils keeps magnetic flux therein without affecting the flux flow in the toroidal coil adjacent thereto to eliminate a magnetic isolation layer between the toroidal coils.

3. The multiple output magnetic induction unit according to claim 1, wherein the magnetic substrate is an insulative substrate.

4. The multiple output magnetic induction unit according to claim 1, wherein the magnetic substrate includes a first principal surface, a second principal surface, a through hole, and an electrode provided on each of the first and second principal surfaces of the magnetic substrate, the electrode on the first principal surface being electrically connected to the electrode on the second principal surface through the through hole.

5. A multiple output micro power converter, comprising:
the multiple output magnetic induction unit according to claim 1,
a power supply IC, and
a capacitor.
